(19) United States
(12) Patent Application Publication
(10) Pub. No.: US 2010/0073238 A1
(43) Pub. Date: Mar. 25, 2010

(54) MICROSTRIP PATCH ANTENNA WITH HIGH GAIN AND WIDE BAND CHARACTERISTICS

(75) Inventors: Dong Suk JUN, Daejeon (KR); Jong Tae Moon, Chungcheongnam-do (KR); Kwang-Seong Choi, Daejeon (KR); Yong II Jun, Daejeon (KR); Hee-Bum Jung, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/366,348

(22) Filed: Feb. 5, 2009

(30) Foreign Application Priority Data
Sep. 23, 2008 (KR) 10-2008-0093255

(51) Int. Cl. H01Q 1/38

(52) U.S. Cl. 343/700 MS

(57) ABSTRACT

Provided is a microstrip patch antenna. The microstrip patch antenna includes a dielectric layer, a feed circuit disposed in the dielectric layer, at least one slot disposed in the dielectric layer and vertically spaced apart from the feed circuit, and a patch antenna disposed outside the dielectric layer and vertically spaced apart from the at least one slot.

### CROSS-REFERENCE TO RELATED APPLICATIONS

This U.S. non-provisional patent application claims priority under 35 U.S.C. § 119 of Korean Patent Application No. 10-2008-93255, filed on Sep. 23, 2008, the entire contents of which are hereby incorporated by reference.

### BACKGROUND OF THE INVENTION

The invention disclosed herein relates to an antenna, and more particularly, to a microstrip patch antenna.

As we enter the ubiquitous era, a necessity for providing various services to consumers has been increased in a recent trend. One of solutions for the above necessity is a fusion technology for creating new services by integrating various functions.

As one potential realization plan for the fusion technology, System In Package (SIP) or System On Package (SOP) technology comes into the spotlight. The reason is that even if materials or manufacturing processes of devices or components constituting a system are different, the devices or the components can be integrated into one package or module. According thereto, performance improvement, microminiaturization, and price lowering are possible.

In a high speed transmission wireless network, quality, security, reliability, and a high speed transmission cost of communication service need to be maintained. Therefore, modules or systems used in the high speed transmission wireless network are required to obtain a wideband and a transmission distance. Accordingly, a microstrip patch antenna for satisfying the above requirements becomes in demand.

### SUMMARY OF THE INVENTION

The present invention provides a microstrip patch antenna with high gain and wide band characteristics.

Embodiments of the present invention provide microstrip patch antennas including: a dielectric layer; a feed circuit disposed in the dielectric layer; at least one slot disposed in the dielectric layer and vertically spaced apart from the feed circuit; and a patch antenna disposed outside the dielectric layer and vertically spaced apart from the at least one slot.

In some embodiments, the dielectric layer comprises a stacked layer of a plurality of Low Temperature Co-fired Ceramic (LTCC) substrates, a plurality of silicon substrates, a plurality of printed circuit boards (PCBs), or a plurality of liquid crystal polymer (LCP) substrates.

In other embodiments, the feed circuit includes a feed line and an open line of a microstrip line, a strip line, or an embedded line.

In still other embodiments, the slot includes a first slot and a second slot, the second slot being vertically spaced apart from the first slot and having a different size than the first slot.

In even other embodiments, the microstrip patch antennas further include an air cavity disposed below the feed circuit outside the dielectric layer.

In yet other embodiments, the microstrip patch antennas further include a patch disposed in the dielectric layer and vertically spaced apart from the patch antenna.

In further embodiments, the patch is disposed between the patch antenna and the at least one slot or between the slots.

In other embodiments of the present invention, microstrip patch antennas include: a feed circuit layer including a feed line and an open line; a slot layer stacked on the feed circuit layer, the slot layer including at least one slot; and an antenna layer stacked on the slot layer, the antenna layer including a patch antenna.

In some embodiments, the feed circuit layer include: a first dielectric substrate where the feed line and the open line are disposed; and an air cavity disposed below the first dielectric substrate.

In other embodiments, the slot layer includes: a second dielectric substrate stacked on the first dielectric substrate, the second dielectric substrate including a first slot of a first size; and a third dielectric substrate stacked on the second dielectric substrate, the third dielectric substrate including a second slot of a second size different from the first size.

In still other embodiments, each of the second and third dielectric substrates further includes a ground layer thereon.

In even other embodiments, the antenna layer includes a fourth dielectric substrate, the fourth dielectric substrate being stacked on the third dielectric substrate and having an open top surface on which the patch antenna is disposed.

In yet other embodiments, each of the first to fourth substrates includes at least one LTCC substrate, at least one silicon substrate, at least one PCB, or at least one LCP substrate.

In further embodiments, the microstrip patch antennas further include a patch layer disposed below the antenna layer, the patch layer including a dielectric substrate where a patch is disposed.

In still further embodiments, the patch layer is disposed in the slot layer, and the patch is disposed between the slots.

In even further embodiments, the patch layer is disposed above the slot layer, and the patch is disposed between the at least one slot and the patch antenna.

In still other embodiments of the present invention, microstrip patch antennas include: a first dielectric substrate including a feed line and an open line; a second dielectric substrate stacked on the first dielectric substrate and including a first slot; a third dielectric substrate stacked on the second dielectric substrate and including a second slot, the second slot having a different size than the first slot; a fourth dielectric substrate staked on the third dielectric substrate and having an open top surface on which a patch antenna is disposed; and a fifth dielectric substrate disposed below the fourth dielectric substrate and having a top surface where a patch is disposed.

In some embodiments, the fifth dielectric substrate is disposed between the third and fourth dielectric substrates or between the second and third dielectric substrates.

In other embodiments, each of the first to fifth dielectric substrates includes at least one LTCC substrate, at least one silicon substrate, at least one PCB, or at least one LCP substrate.

In still other embodiments, each of the second and third dielectric substrates further includes a ground layer thereon.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1A is an exploded perspective view of a microstrip patch antenna according to a first embodiment of the present invention;

FIG. 1B is a plan view of the microstrip patch antenna of FIG. 1A;

FIG. 1C is a cross-sectional view of the microstrip patch antenna of FIG. 1A;

FIGS. 2A through 2D are graphs illustrating characteristics of the microstrip patch antenna according to the first embodiment of the present invention;

FIG. 3 is an exploded perspective view of a microstrip patch antenna according to a second embodiment of the present invention;

FIGS. 4A through 4D are graphs illustrating characteristics of the microstrip patch antenna of the second embodiment of the present invention;

FIG. 5 is an exploded perspective view of a microstrip patch antenna according to a third embodiment of the present invention;

FIGS. 6A through 6D are graphs illustrating characteristics of the microstrip patch antenna of the third embodiment of the present invention;

FIG. 7 is an exploded perspective view of a microstrip patch antenna according to a fourth embodiment of the present invention;

FIGS. 8A through 8D are graphs illustrating characteristics of the microstrip patch antenna according to the fourth embodiment of the present invention;

FIG. 9 is an exploded perspective view of a microstrip patch antenna according to a fifth embodiment of the present invention;

FIGS. 10A through 10D are graphs illustrating characteristics of the microstrip patch antenna according to the fifth embodiment;

FIG. 11A is an exploded perspective view of a microstrip patch antenna according to a sixth embodiment of the present invention;

FIG. 11B is a plan view of the microstrip patch antenna of FIG. 11A;

FIG. 11C is a cross-sectional view of the microstrip patch antenna of FIG. 11A;

FIGS. 12A through 12D are graphs illustrating characteristics of the microstrip patch antenna according to the sixth embodiment;

FIG. 13 is an exploded perspective view of a microstrip patch antenna according to a seventh embodiment of the present invention;

FIGS. 14A through 14D are graphs illustrating characteristics of the microstrip patch antenna according to the seventh embodiment;

FIG. 15 is an exploded perspective view of a microstrip patch antenna according to an eighth embodiment of the present invention;

FIGS. 16A through 16D are graphs illustrating characteristics of the microstrip patch antenna according to the eighth embodiment of the present invention;

FIG. 17A is an exploded perspective view of a microstrip patch antenna according to a ninth embodiment of the present invention;

FIG. 17B is a plan view of the microstrip patch antenna of FIG. 17A;

FIG. 17C is a cross-sectional view of the microstrip patch antenna of FIG. 17A; and

FIGS. 18A through 18D are graphs illustrating characteristics of the microstrip patch antenna according to the ninth embodiment of the present invention.

### DETAILED DESCRIPTION OF PREFERRED EMBODIMENTS

Hereinafter, a microstrip patch antenna of the present invention will be described in detail with reference to the accompanying drawings.

Comparative advantages of the present invention with respect to the related art will be clear through detailed description and the claims, with reference to the accompanying drawings. Especially, the present invention is only defined by scopes of the claims. However, the present invention will be more clearly understood with reference to the following detailed description through the accompanying drawings. Like reference numerals refer to like elements throughout.

### First Embodiment

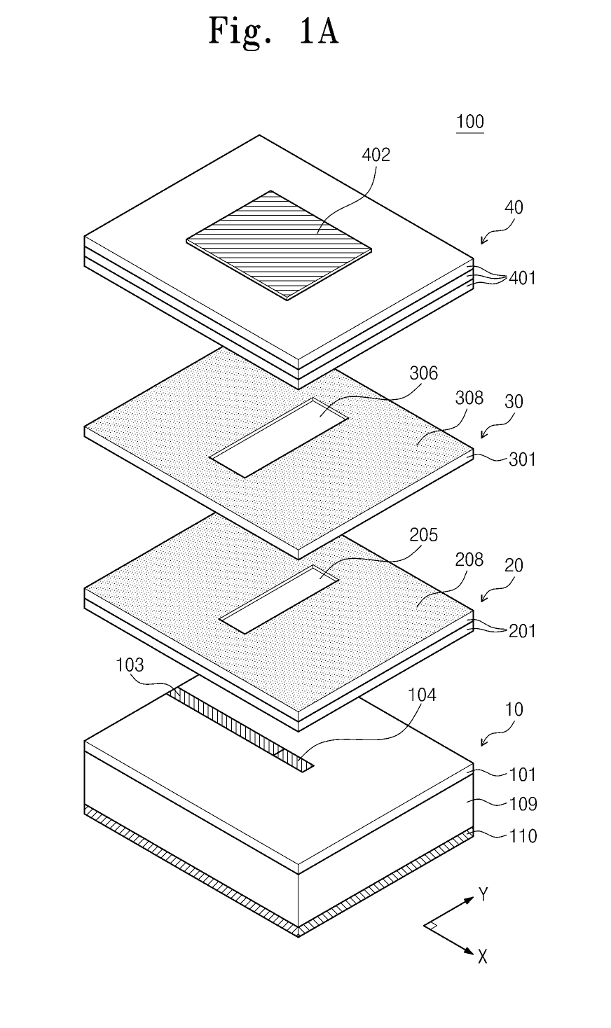

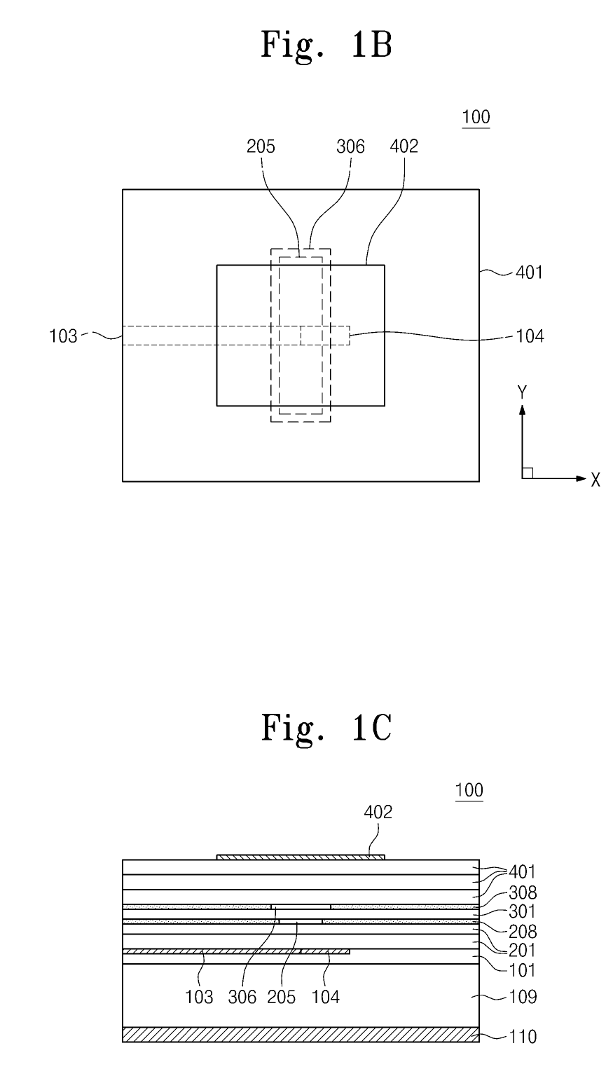

FIG. 1A is an exploded perspective view of a microstrip patch antenna according to a first embodiment of the present invention. FIG. 1B is a plan view of the microstrip patch antenna of FIG. 1A. FIG. 1C is a cross-sectional view of the microstrip patch antenna of FIG. 1A.

Referring to FIGS. 1A through 1C, the microstrip patch antenna 100 of the first embodiment is a kind of a micro planar antenna manufactured using a principle in which a high frequency is emitted through an open surface of a microstrip line. In general, since a microstrip patch antenna has a high degree of integration and a low price, it is ready for mass production. The microstrip patch antenna is small, compact, and light and is manufactured with a planar arrangement. However, since the microstrip patch antenna has a narrowband characteristic, there are limitations in applying the microstrip patch antenna to extensive applications.

To improve a narrowband characteristic, suggested are a method using a physical stack structure, a method using aperture coupling, a method for arranging a parasite device in the neighborhood, a method for increasing a thickness of a dielectric substrate, and a method for additionally inserting an impedance expansion circuit of a feed line. Especially, according to an embodiment of the present invention, a stack slot is used to improve a narrowband characteristic in order to realize a broad frequency bandwidth, a high antenna gain, and easy impedance matching. In one embodiment of the present invention, for example, a microstrip patch antenna of a stack slot structure, emitting signals via a wireless personal area network of a 60 GHz band, is designed. HFSS™ may be used as a design tool.

For example, the microstrip patch antenna 100 is largely divided into four layers, for convenience. A first layer 10 may include a feed circuit. A second layer 20 and a third layer 30 may include slots. A fourth layer 40 may include a patch antenna.

The first layer 10 may include a feed line 103 and an open stub or open line 104 in the first substrate 101. For example, at least one of the feed line 103 and the open line 104 may be an embedded microstrip, a microstrip, or a strip line form.

The first layer 10 may further include an air cavity 109 and a metal cover 110. The air cavity 109 serves to reduce the loss of energy emitted from the feed line 103. The feed line 103 and the open line 104 may extend in a first direction, for example, an X-direction. The first substrate 101 may be a dielectric substrate. For example, the first substrate 101 may be a Low Temperature Co-fired Ceramic (LTCC) substrate. For example, the first substrate 101 may include an LTCC substrate manufactured with a thickness of about 0.1 mm through a material called A6, obtainable from the FERRO company. In another example, the first substrate 101 may be formed of silicon, a printed circuit board (PCB), and liquid crystal polymer (LCP).

The second layer 20, where at least one, for example, two second substrates 201 are stacked, includes a ground layer 208 with a slot 205 (or a pattern slot), which is formed through the upper second substrate among the two second substrates 201. Each of the two second substrates 201 may be formed of the same thickness and/or same material as the first substrate 101. For example, each of the two second substrates 201 may be an LTCC sheet having a thickness of about 0.1 mm. The slot 205 may be a rectangle which extends in a Y-direction perpendicular to the X-direction.

The third layer 30 may include a ground layer 308 where a stack slot 306 (or stack pattern slot) is formed through at least one third substrate 301. The stack slot 306 may be vertically arranged with respect to the slot 205, and may have greater width and length than the slot 205. The third substrate 301 may be an LTCC substrate having a thickness of about 0.1 mm formed of the same thickness and/or same material as the first substrate 101. Since there are two slots 205 and 306, compared to one slot, a wideband characteristic can be realized to improve more energy efficiency and more stable impedance matching.

The fourth layer 40, where at least one, for example, three fourth substrates 401 are stacked, may include a patch antenna 402 on the uppermost substrate. Each of the three fourth substrates 401 may be an LTCC substrate having a thickness of about 0.1 mm formed of the same thickness and/or the same material as the first substrate 101. The microstrip patch antenna described below may have a structure where about seven to nine LTCC substrates are stacked.

A power is fed into the slot 205 and the stack slot 306 through the feed line 103. The fed power is transmitted to the patch antenna 402 through the fourth substrate 401 above the stack slot 306. According to the size and position of the slot 205, antenna impedance and reactance may vary. An input impedance toward the patch antenna 402 from the feed line 103 may be an impedance sum of the slot 205, the stack slot 306, and the patch antenna 402. Energy change may be a feed line voltage ratio of the slot 205 and the stack slot 306. The stack slot 306 is electrically connected to the slot 205 through the feed line 103. The size of the stack slot 306 may be designed different from that of the slot 205 in order to determine a somewhat different frequency. Important variables for determining a characteristic of the microstrip patch antenna 100 having the stack slot structure include a dielectric thickness, a permittivity, the size of the patch antenna 402, the length of the open line 104, the sizes of the slot 205 and the stack slot 306, and the position of a feed point.

One patch antenna 402 and two slots 205 and 306 constitute three resonators. Each resonator has mutual coupling that is mutually related to an impedance loop. Additionally, its wideband and high gain characteristics can be maintained by changing factors of each resonator during each impedance loop. The factors of each resonator may include the thicknesses of substrates between the slot 205, the stack slot 306, and the patch antenna 402, the width and length of the slot 205 and the stack slot 306, and the length of the open line 104.

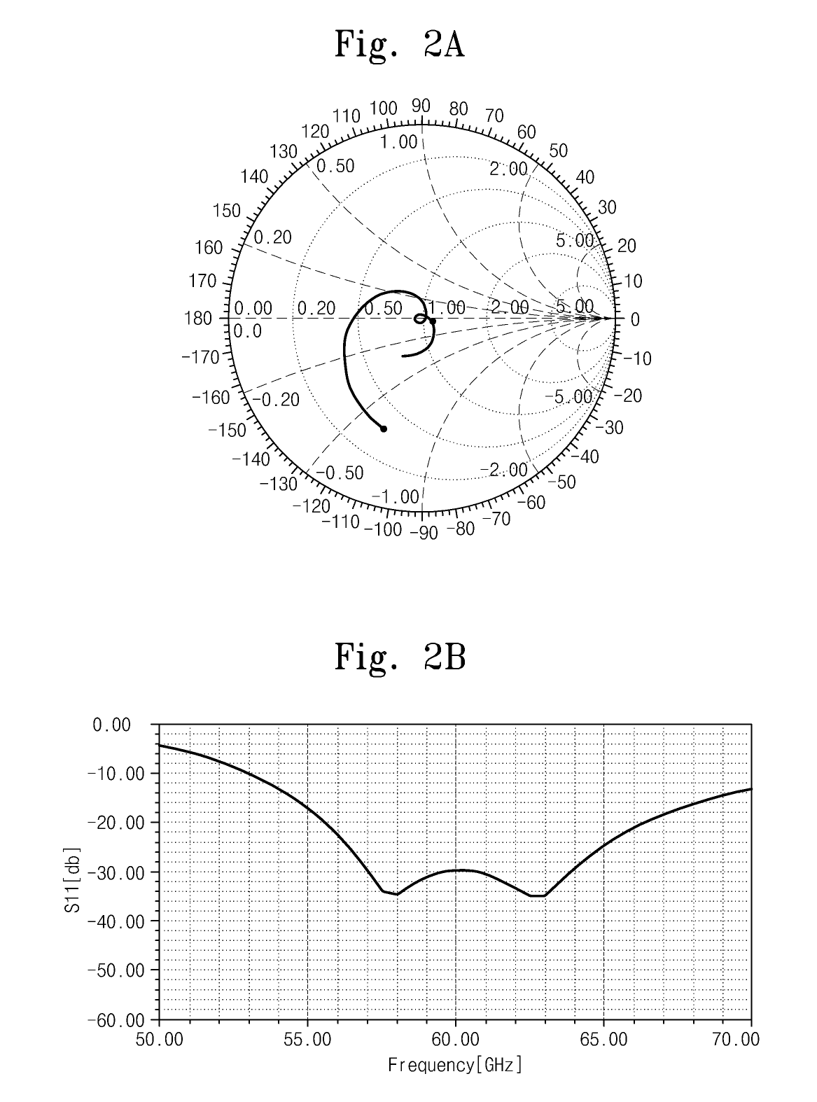

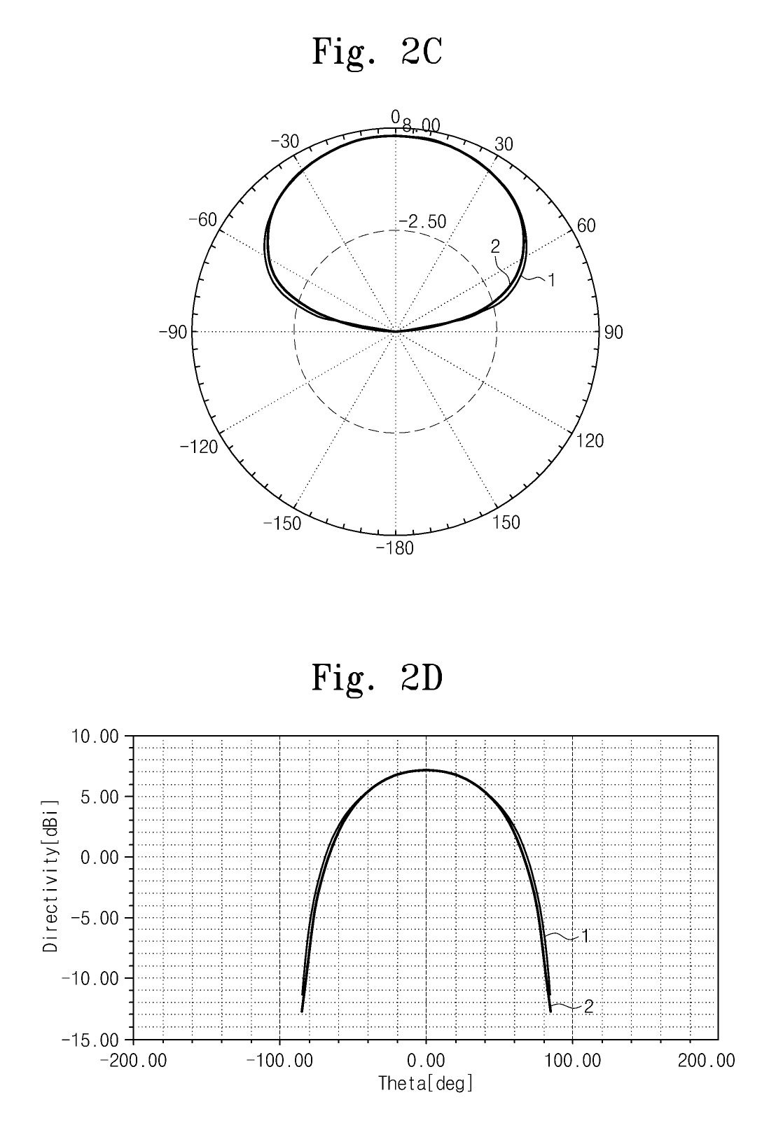

FIGS. 2A through 2D are graphs illustrating characteristics of the microstrip patch antenna 100 according to the first embodiment of the present invention.

FIG. 2A is a smith chart where a relationship between an impedance and a reflection coefficient is illustrated. It is determined that a wideband characteristic of the microstrip patch antenna 100 is excellent based on the fact that an impedance locus is close to the center of a circle.

FIG. 2B illustrates a reflection coefficient. In FIG. 2B, radiation efficiency of an antenna becomes higher and matching becomes more easily accomplished as a reflection coefficient drops deeper at a specific frequency. As the valley becomes broader, a frequency bandwidth of an antenna becomes broader. For one example, with respect to about −30 dB of the reflection coefficient S11, a frequency bandwidth of the microstrip patch antenna 100 represents a wideband characteristic satisfying about 57 GHz to about 64 GHz.

FIG. 2C illustrates a radiation pattern (an antenna pattern) having an antenna characteristic radiating or receiving a high frequency in a desirable direction. The radiation pattern of the microstrip patch antenna 100 radiates with an E-pattern 1 and an H-pattern 2 having almost same characteristics in all bands. The E-pattern 1 is a radiation pattern measured at a plane including a direction at which an electric field vector and the maximum radiation are achieved, and the H-pattern is a radiation pattern measured at a plane including a direction at which a magnetic field and the maximum radiation are achieved.

FIG. 2D illustrates an antenna gain, that is, a relative gain derived from the directivity of the microstrip patch antenna 100. The microstrip patch antenna 100 may achieve an antenna gain of about 7.2 dBi. In general, a gain and a bandwidth of an antenna are in a trade-off relationship, but the microstrip patch antenna 100 of this embodiment can achieve a high gain as illustrated in FIG. 2D, and also satisfies a wideband as illustrated in FIG. 2B.

### Second Embodiment

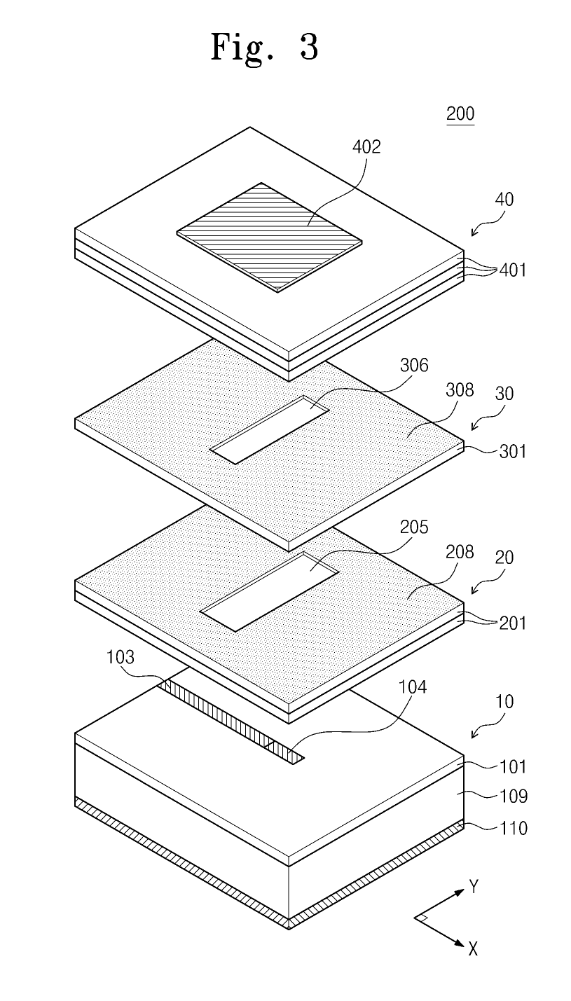

FIG. 3 is an exploded perspective view of a microstrip patch antenna according to a second embodiment of the present invention.

Referring to FIG. 3, the microstrip patch antenna 200 of the second embodiment may be configured similar to that of the first embodiment. Unlike the microstrip patch antenna 100 of the first embodiment, according to the microstrip patch antenna 200 of the second embodiment, the slot 205 has greater width and length than the stack slot 306. Except this, all other component descriptions of the first embodiment can be applied to this embodiment.

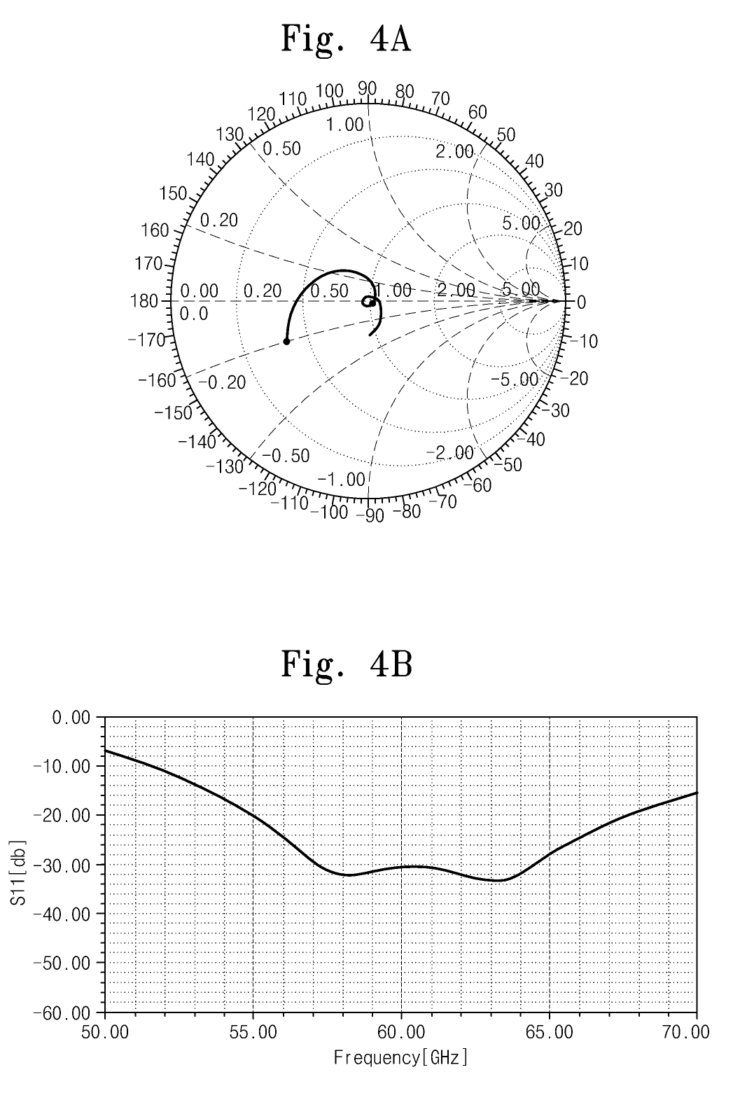

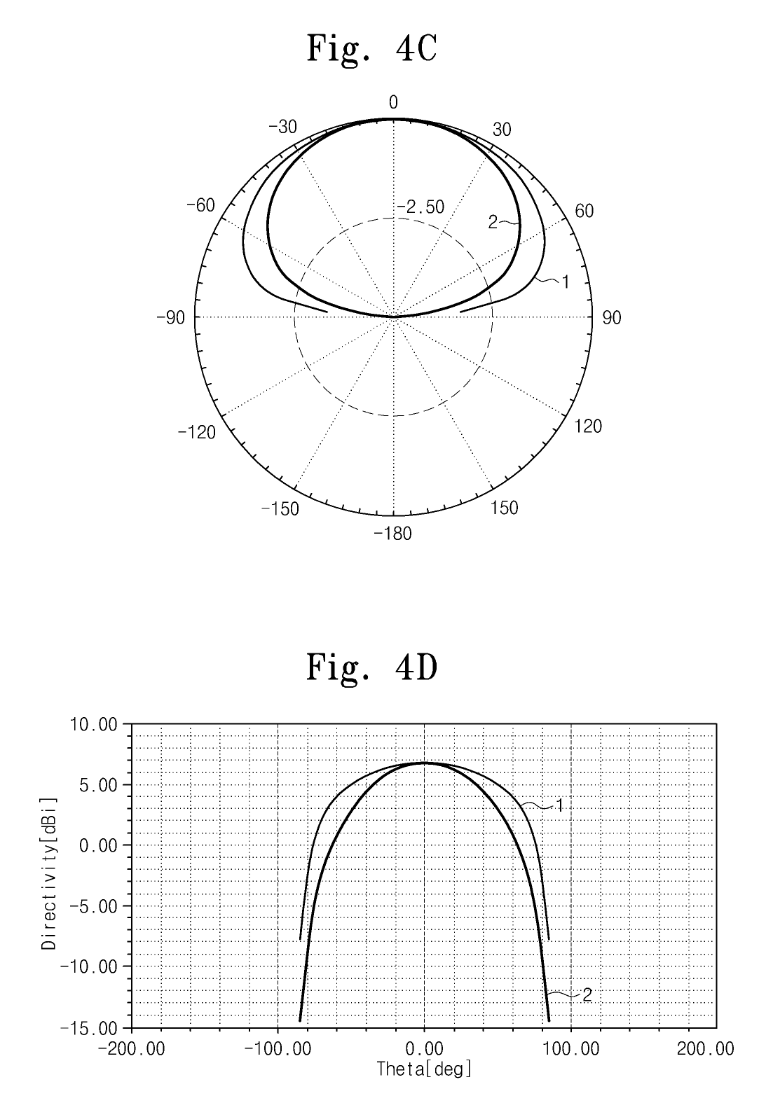

FIGS. 4A through 4D are graphs illustrating characteristics of the microstrip patch antenna 200 of the second embodiment. FIG. 4A illustrates a smith chart of the microstrip patch antenna 200. FIG. 4B illustrates a reflection coefficient of the microstrip patch antenna 200. FIG. 4C illustrates a radiation pattern of the microstrip patch antenna 200. FIG. 4D illustrates an antenna gain of the microstrip patch antenna 200.

Especially, referring to FIGS. 4B and 4D, the microstrip patch antenna 200 has a wideband characteristic satisfying about 56 GHz to about 64 GHz and a high gain characteristic of about 6.8 dBi, with respect to a reflection coefficient of about −30 dB.

### Third Embodiment

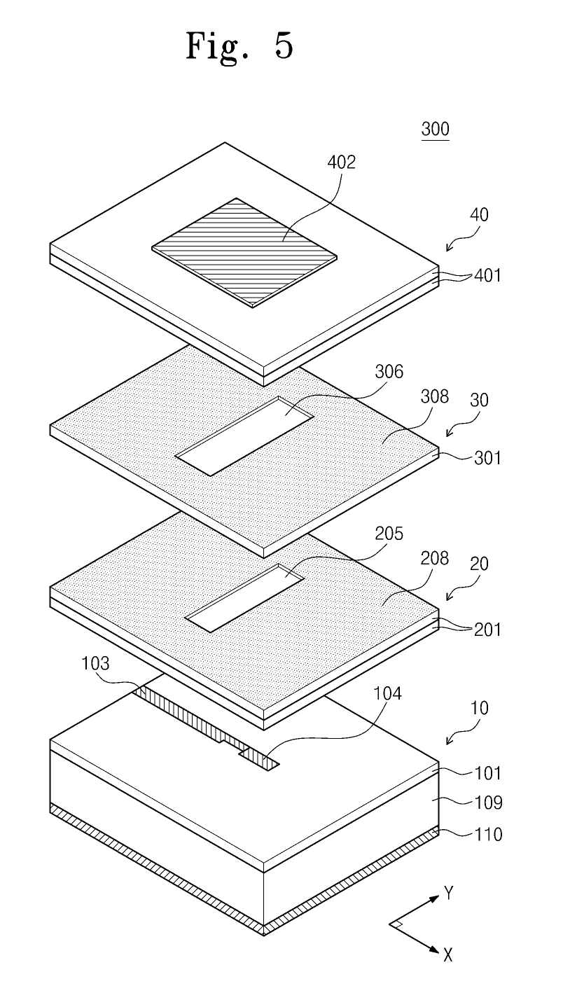

FIG. 5 is an exploded perspective view of a microstrip patch antenna according to a third embodiment of the present invention.

Referring to FIG. 5, the microstrip patch antenna 300 of the third embodiment may have a structure similar to that of the first embodiment. Unlike the microstrip patch antenna 100 of the first embodiment, according to the microstrip patch antenna 300 of the third embodiment, the length of the open line 104 may be designed different from that of the first embodiment. If the length of the open line 104 is changed, an input impedance value may be changed. Except this, all other descriptions of the first embodiment can be applied to this embodiment.

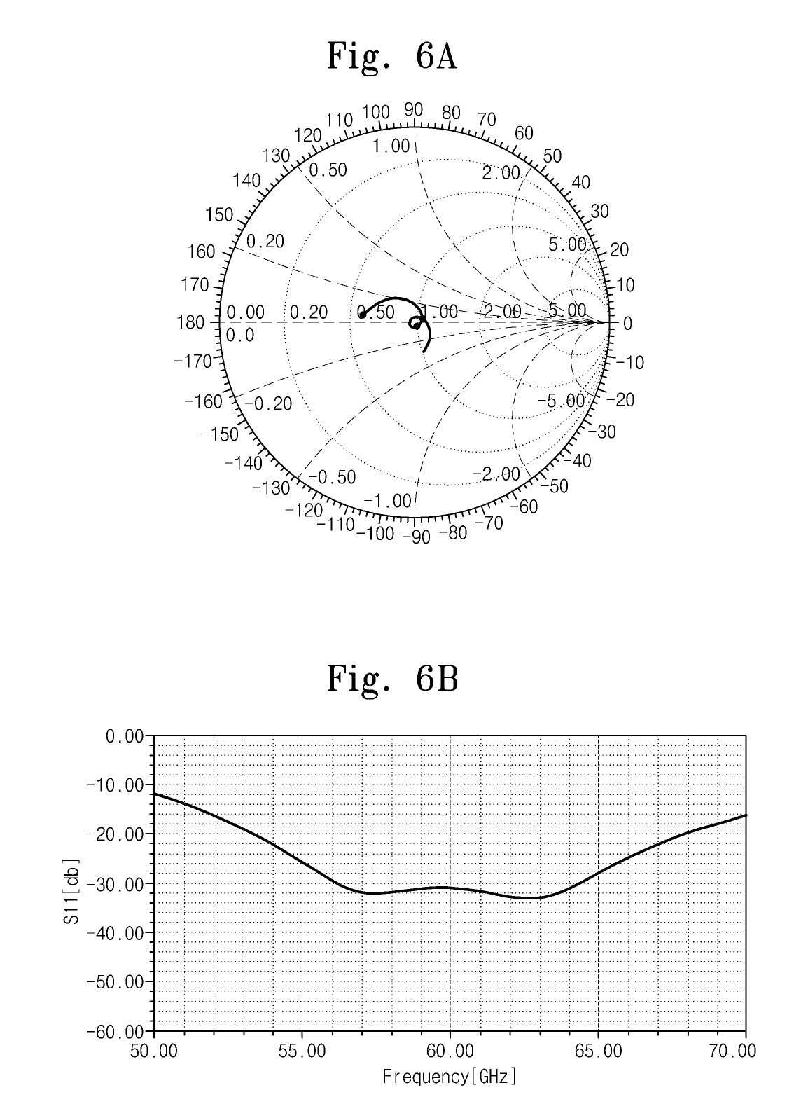

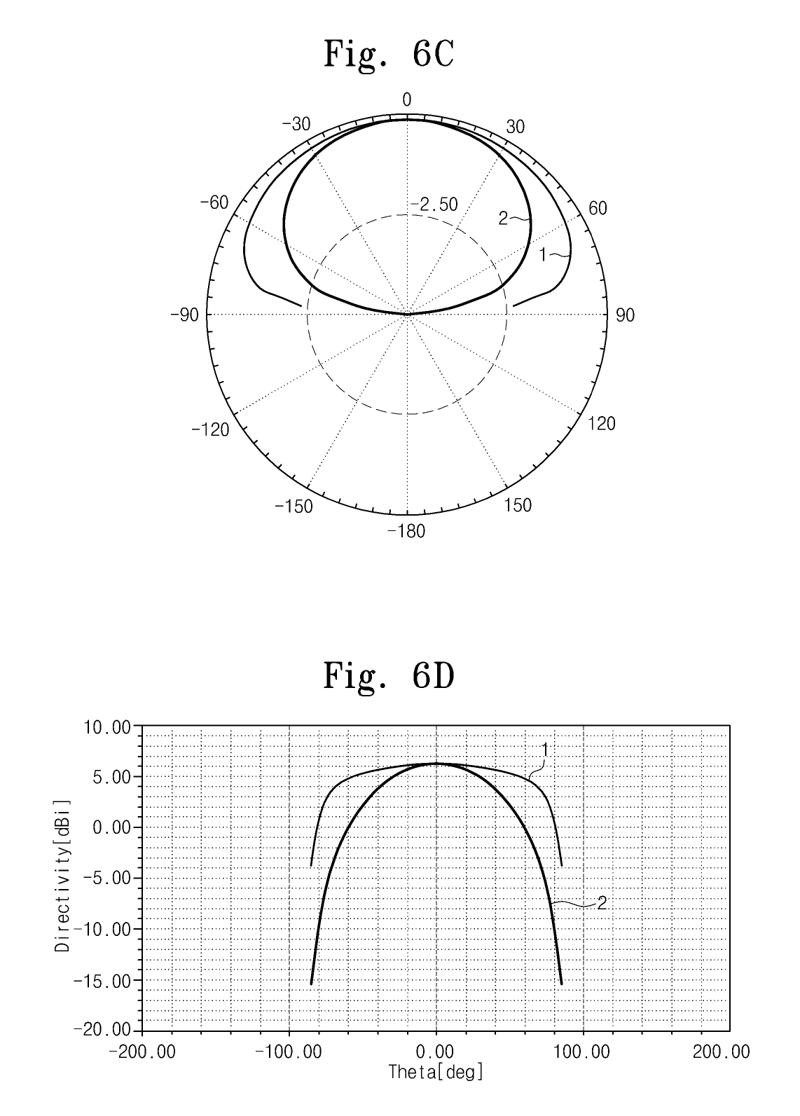

FIGS. 6A through 6D are graphs illustrating characteristics of the microstrip patch antenna 300 of the third embodiment. Especially, referring to FIGS. 6B and 6D, the microstrip patch antenna 300 may have a wideband characteristic satisfying about 56 GHz to about 64 GHz and a high gain characteristic of about 6.3 dBi.

### Forth Embodiment

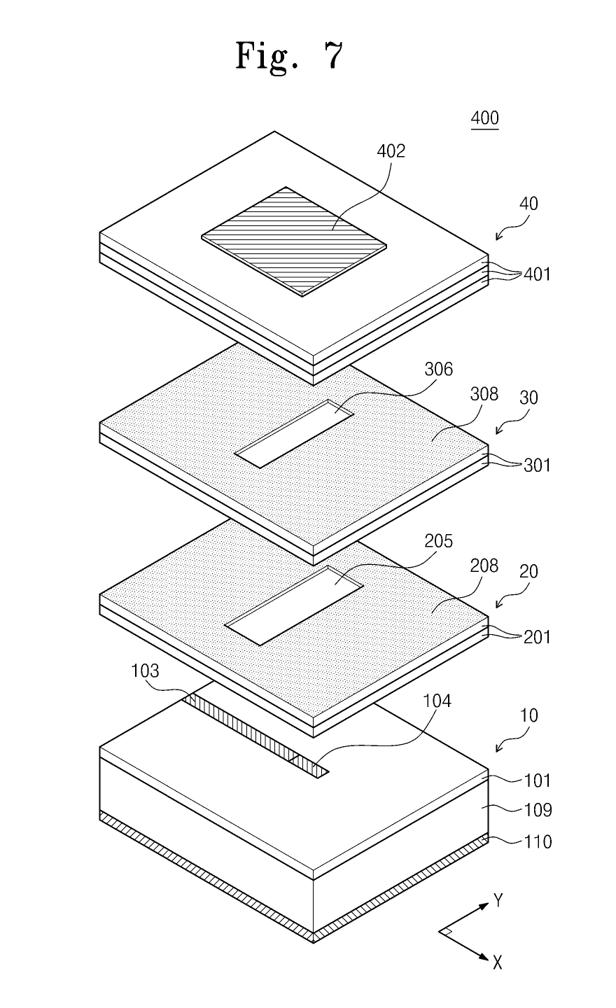

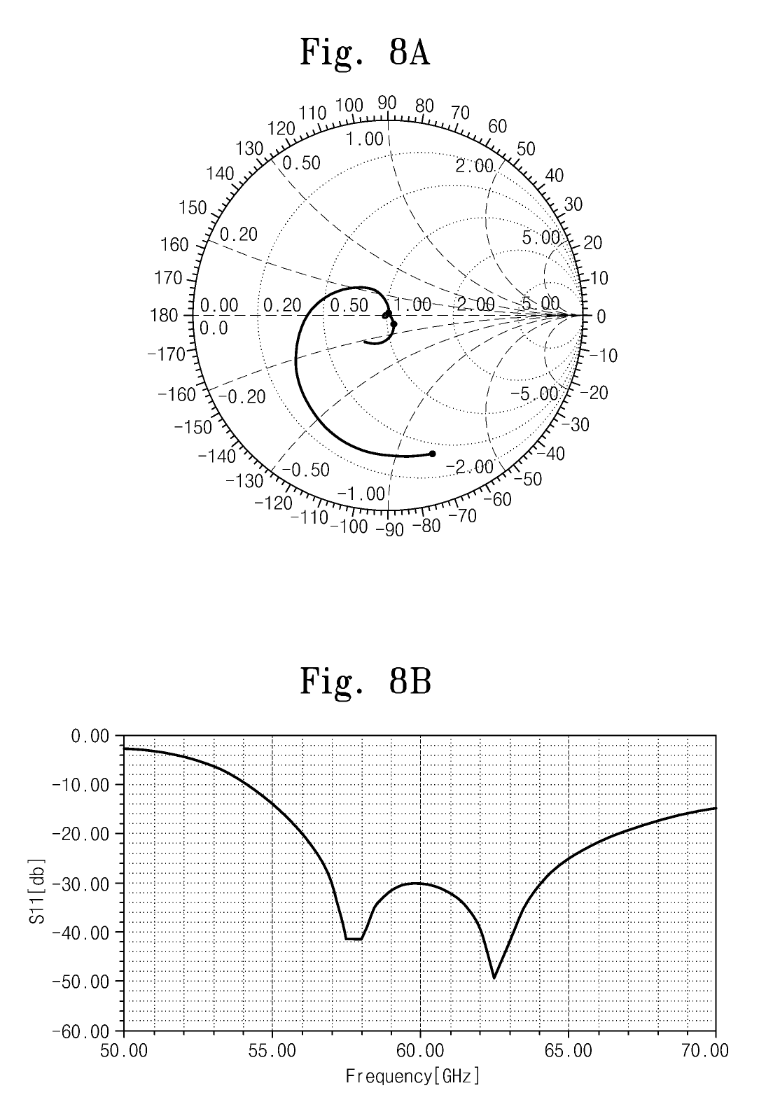

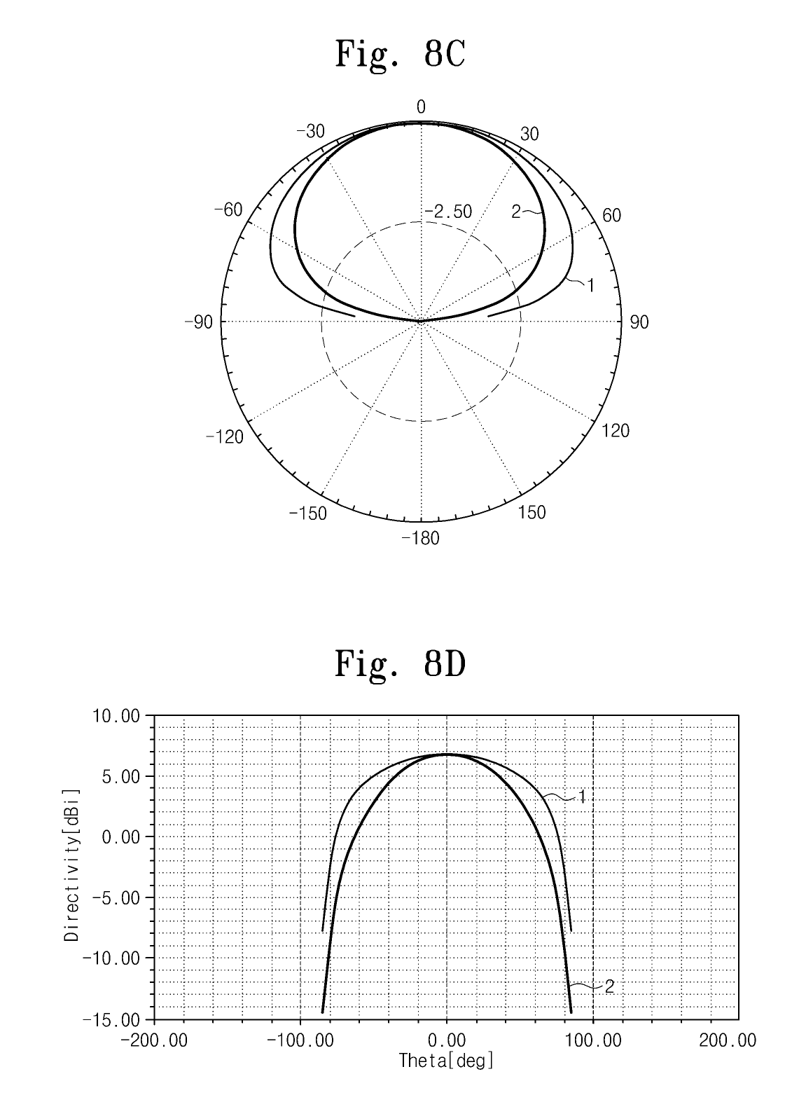

FIG. 7 is an exploded perspective view of a microstrip patch antenna according to a fourth embodiment of the present invention. FIGS. 8A through 8D are graphs illustrating a smith chart, a reflection coefficient, a radiation pattern, and an antenna gain characteristic of the microstrip patch antenna 400, respectively, according to the fourth embodiment.

Referring to FIG. 7, the microstrip patch antenna 400 of the fourth embodiment may have a structure similar to that of the fourth embodiment. Unlike the microstrip patch antenna 100 of the first embodiment, the microstrip patch antenna 400 of the fourth embodiment may include at least one, for example, two third substrates 301. Furthermore, the slot 205 may be designed to have greater width and length than the stack slot 306. Except this, all other components explanations are the same as the first embodiment.

The microstrip patch antenna 400 may have characteristics as shown in FIGS. 8A through 8D. It is apparent that the microstrip patch antenna 400 may have a wideband characteristic (about 57 GHz to about 64 GHz) as shown in FIG. 8B and a high gain characteristic (about 6.9 dBi) as shown in FIG. 8D. Except this, all other component descriptions of the first embodiment can be applied to this embodiment.

### Fifth Embodiment

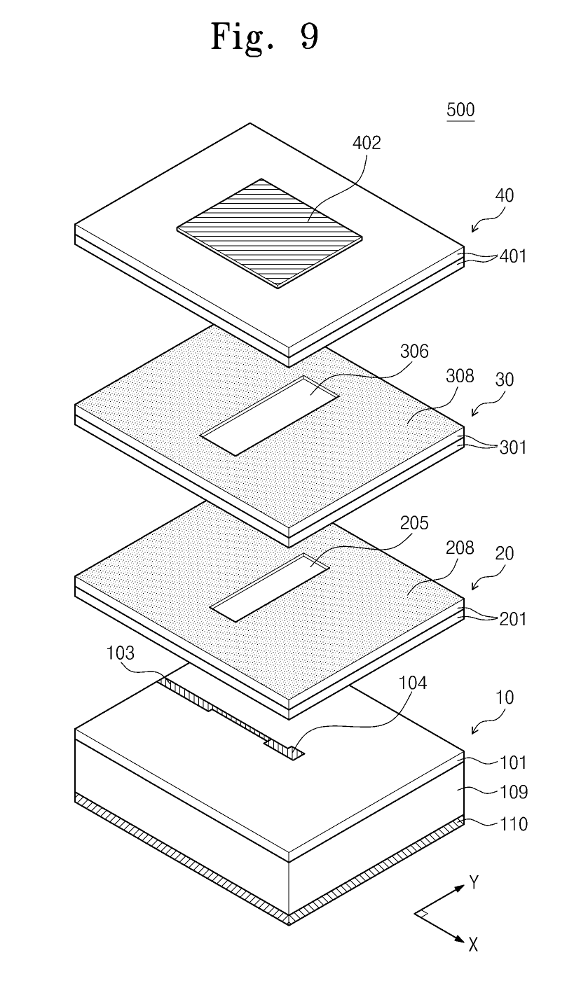

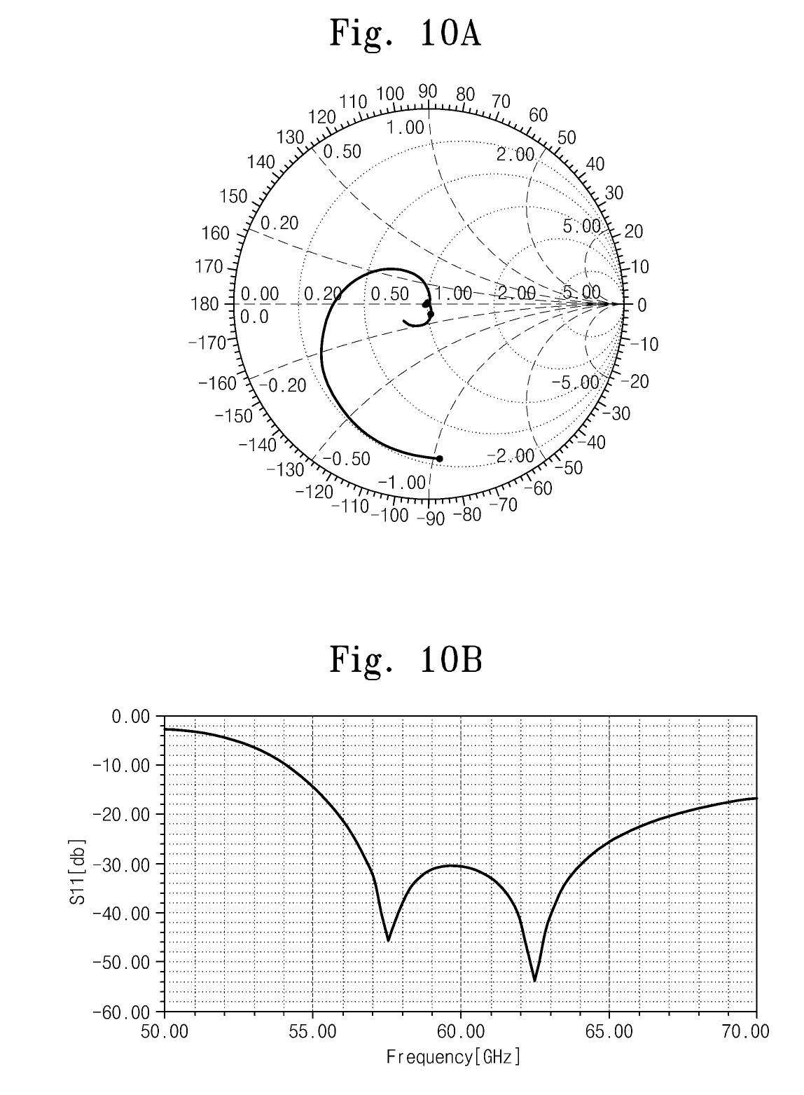

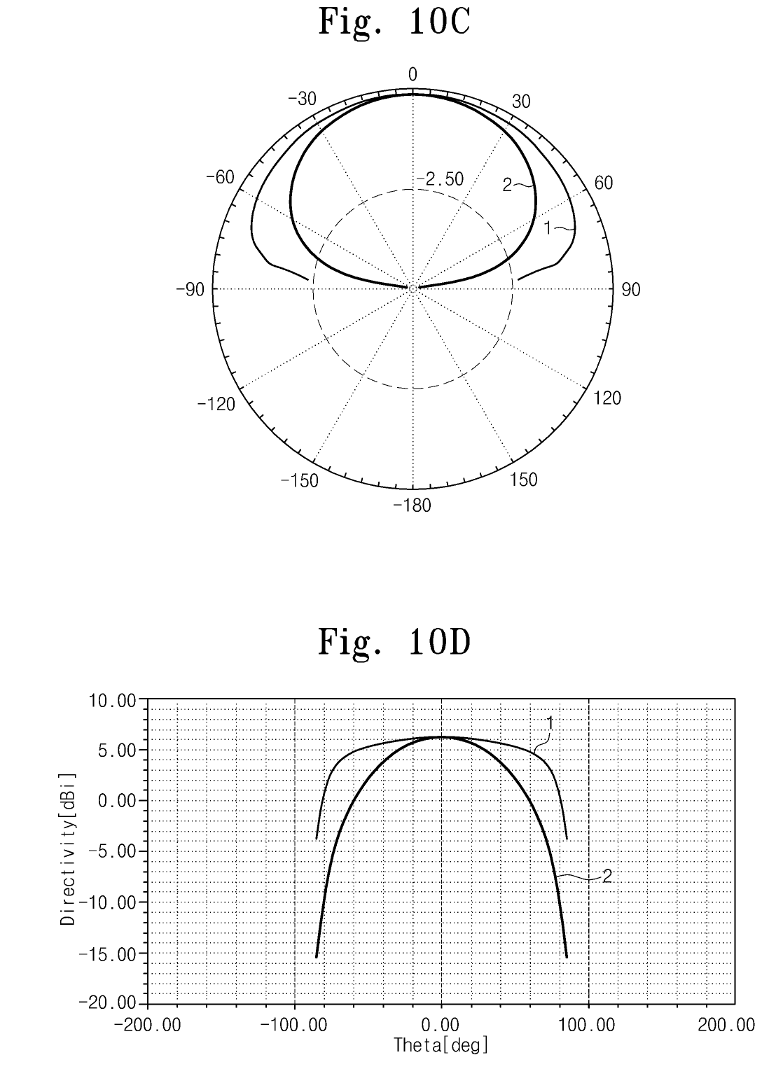

FIG. 9 is an exploded perspective view of a microstrip patch antenna according to a fifth embodiment of the present invention. FIGS. 10A through 10D are graphs illustrating a smith chart, a reflection coefficient, a radiation pattern, and an antenna gain characteristic of a microstrip patch antenna, respectively, according to the fifth embodiment.

Referring to FIG. 9, the microstrip patch antenna 500 of the fifth embodiment may have a structure similar to that of the first embodiment. Unlike the microstrip patch antenna 100 of the first embodiment, the microstrip patch antenna 500 of the fifth embodiment may include at least one, for example, two third substrates 301. Furthermore, the length of the open line 104 may be designed different from that of the first embodiment. Except this, all other components are the same as the first embodiment. Characteristics of the microstrip patch antenna 500 having the above structure are illustrated in FIGS. 10A through 10D. Among them, important interests are a wideband characteristic (about 57 GHz to about 64 GHz) as shown in FIG. 10B and a high gain characteristic (about 6.3 dBi) as shown in FIG. 10D.

### Sixth Embodiment

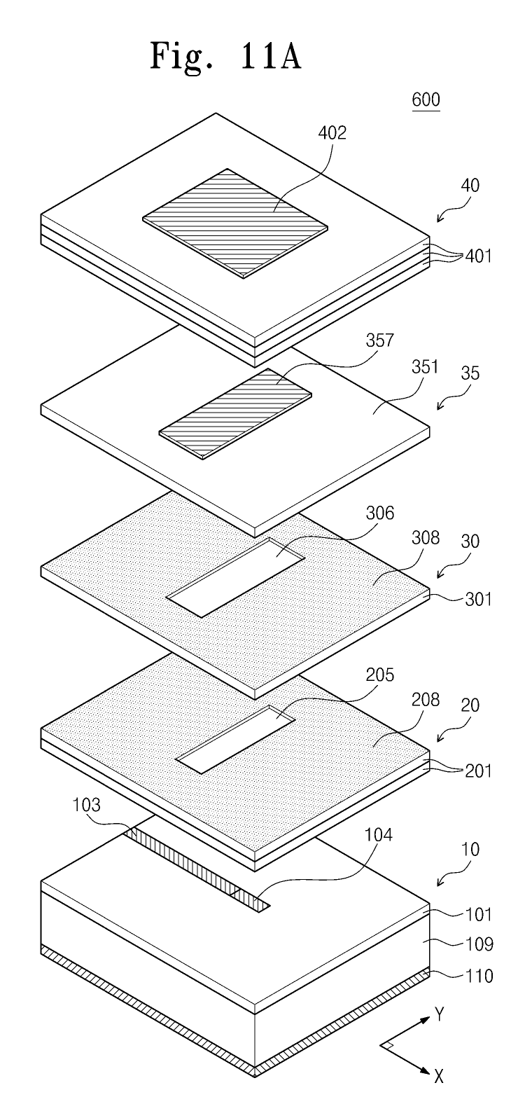

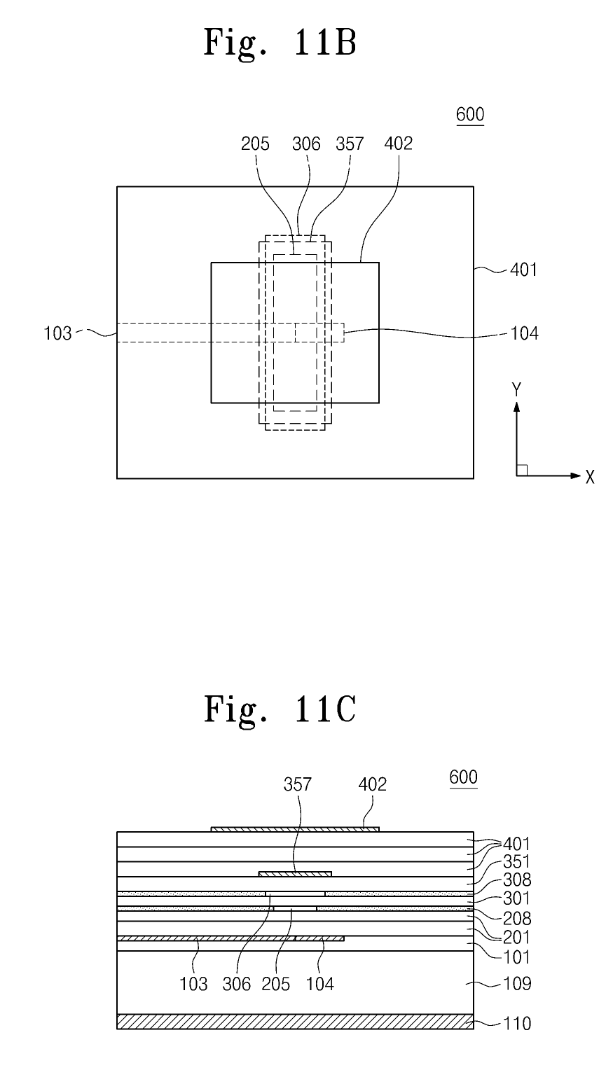

FIG. 11A is an exploded perspective view of a microstrip patch antenna according to a sixth embodiment of the present invention. FIG. 11B is a plan view of the microstrip patch antenna. FIG. 11C is a cross-sectional view of the microstrip patch antenna.

Referring to FIGS. 11A through 11C, the microstrip patch antenna 600 of the sixth embodiment may have a structure similar to that of the first embodiment. Unlike the microstrip patch antenna 100 of the first embodiment, a patch layer 35 including a substrate 351 and a patch 357 may be further disposed between the third layer 30 and the fourth layer 40. The substrate 351 may be an LTCC substrate having a thickness of about 0.1 mm formed of the same thickness and/or same material as the first substrate 101. The patch 357 may be a rectangular shape extended in the Y-direction.

A power is fed into the slot 205 and the stack slot 306 through the microstrip feed line 103. The fed power is parasitically connected to the patch 357 through the substrate 351 on the stack slot 306, and then is transmitted from the parasitically connected patch 357 to the patch antenna 402. An input impedance from the feed line toward the patch antenna 402 may be an impedance sum of the slot 205, the stack slot 306, the patch 357, and the patch antenna 402. The size of the patch 357 may serve as a very informant important factor that determines a characteristic of the microstrip patch antenna 600.

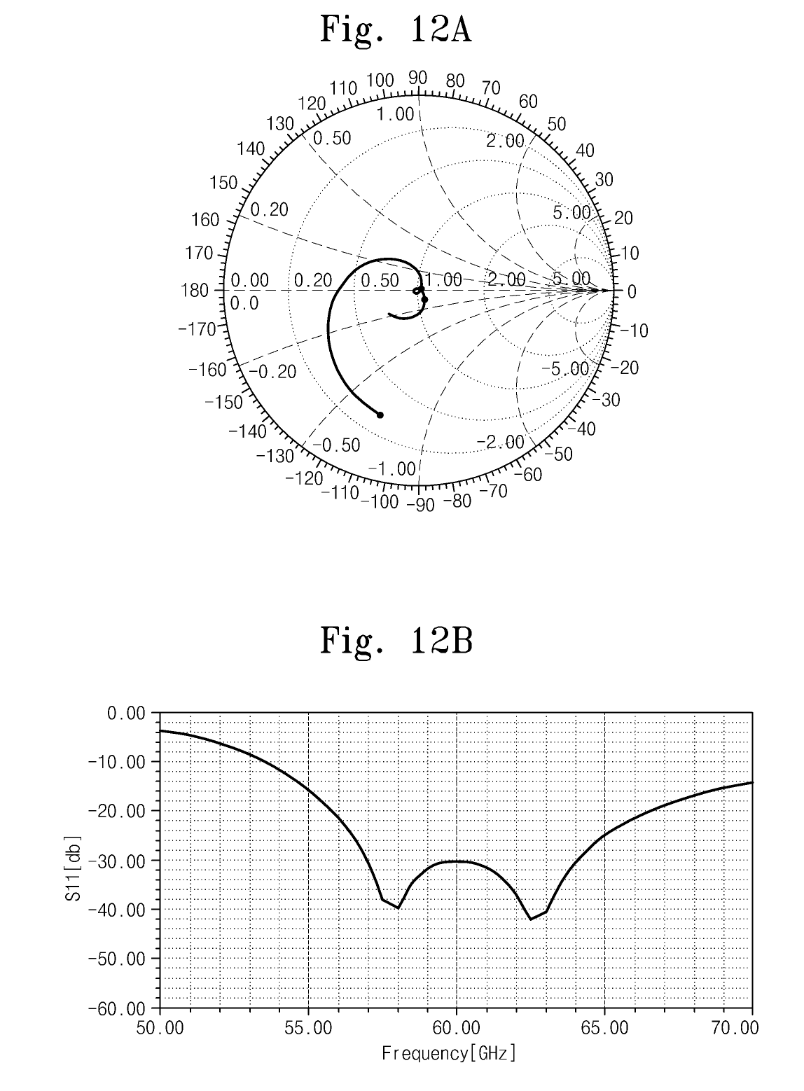

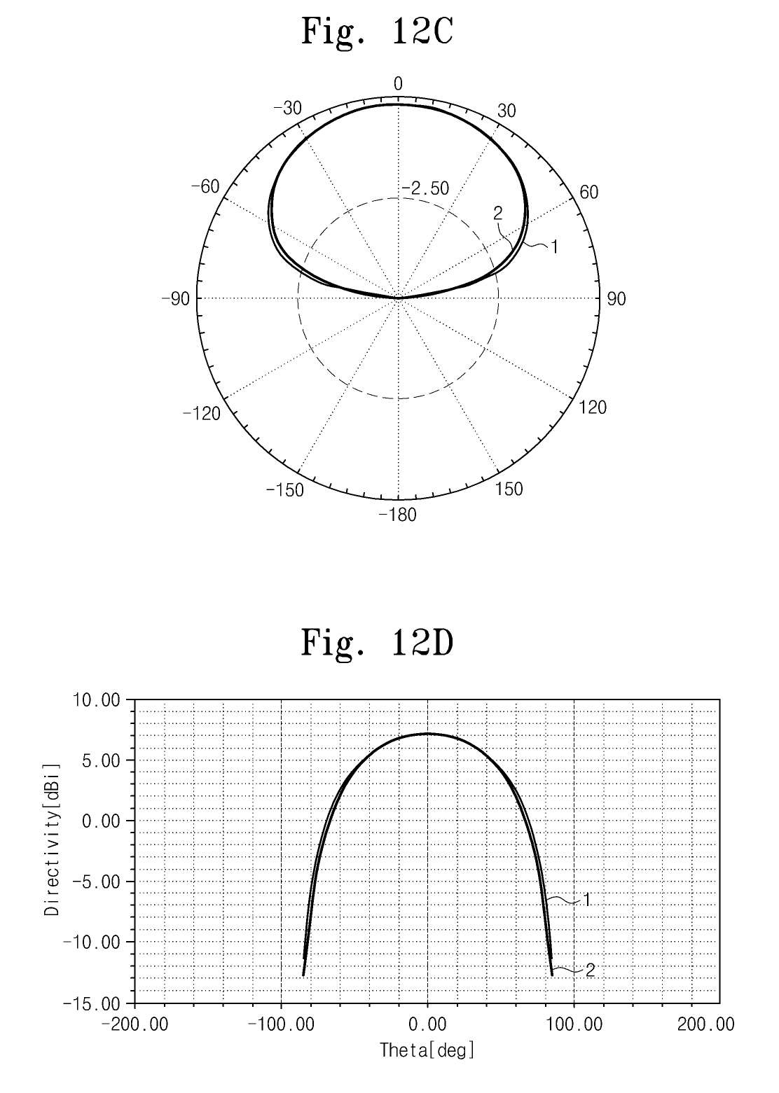

FIGS. 12A through 12D are graphs illustrating a smith chart, a reflection coefficient, a radiation pattern, and an antenna gain characteristic of the microstrip patch antenna 600, respectively, according to the sixth embodiment. As shown in FIG. 12B, with respect to a reflection coefficient of −30 dB, the microstrip patch antenna 600 may have a wideband characteristic having a frequency band of about 57 GHz to about 64 GHz. Furthermore, as illustrated in FIG. 12D, a high antenna gain characteristic of about 7.3 dBi can be obtained.

### Seventh Embodiment

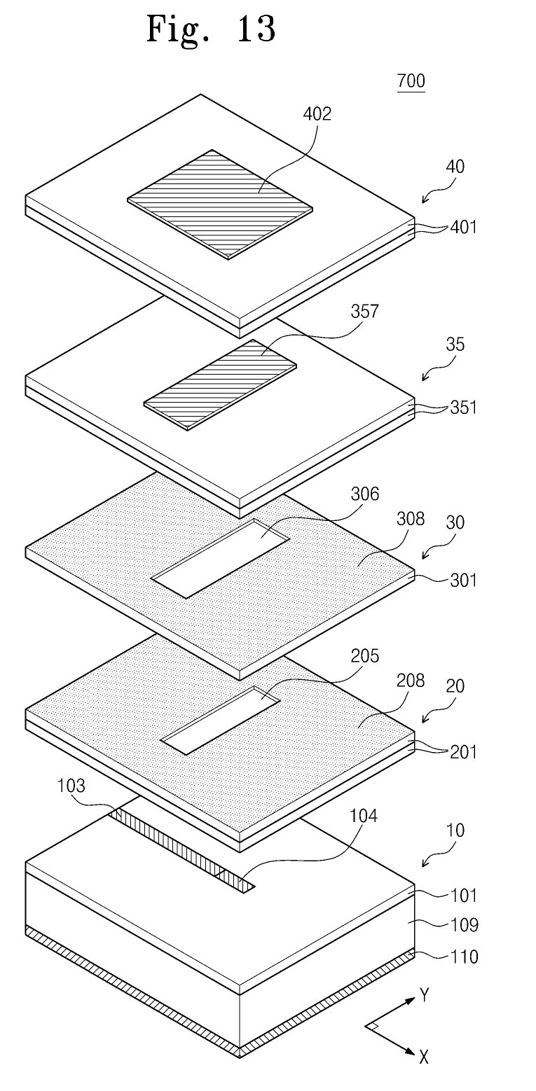

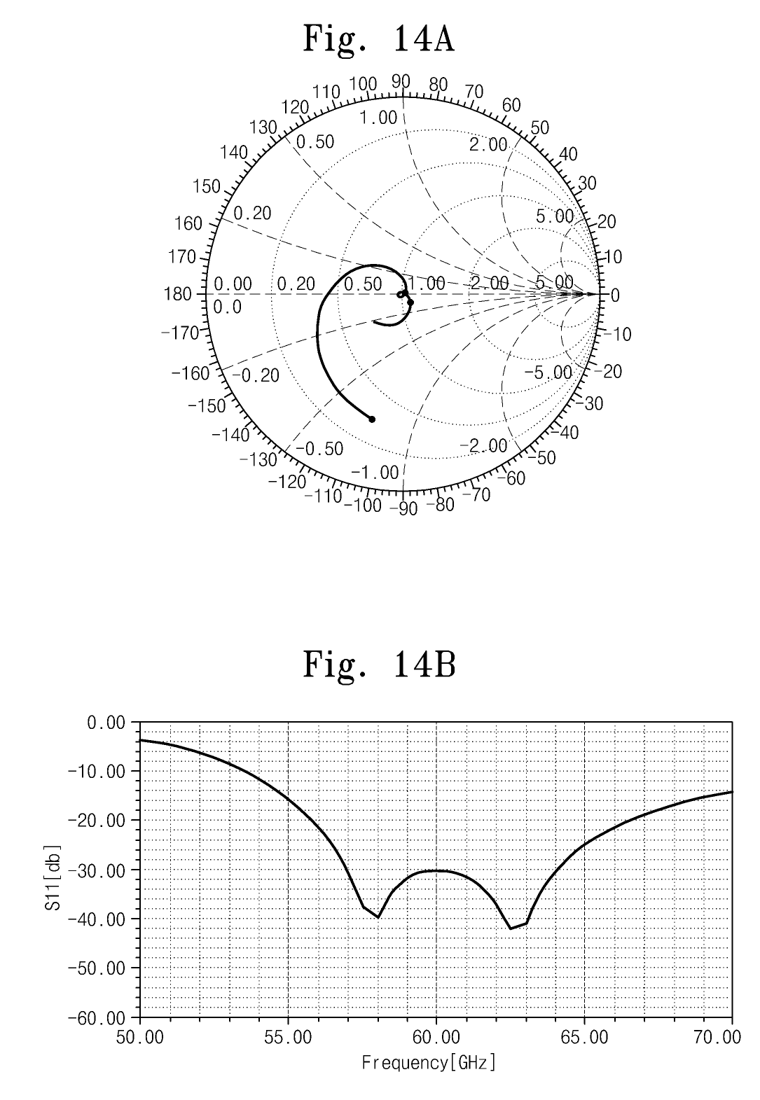

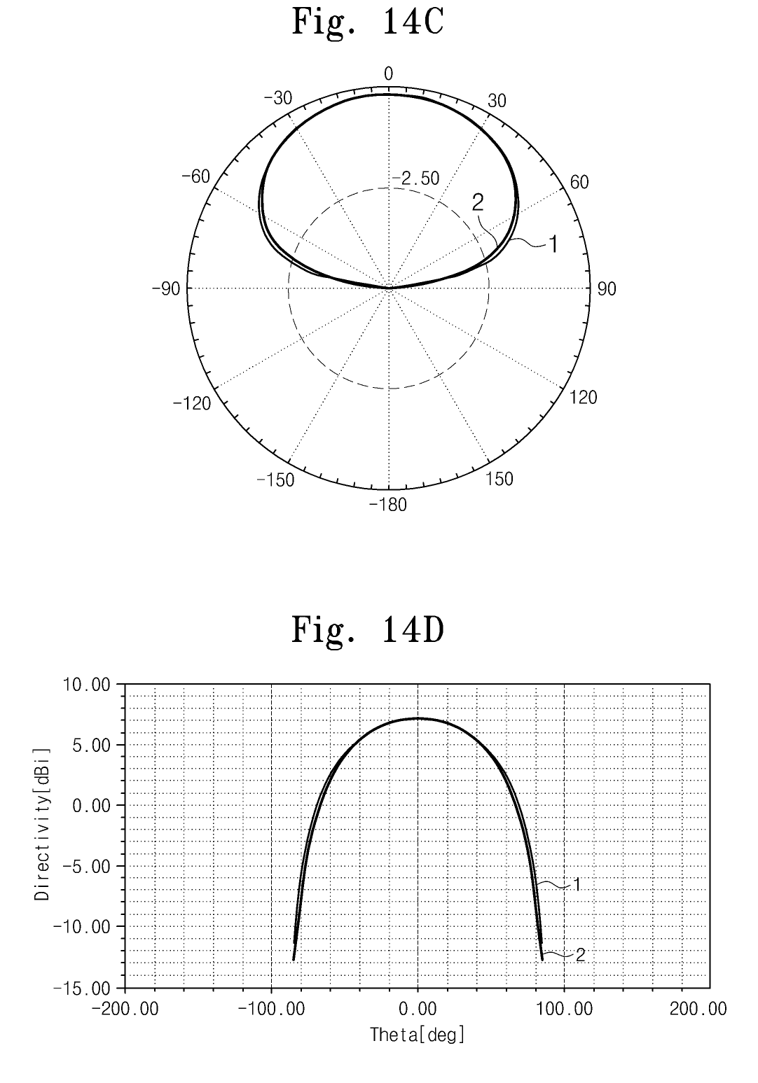

FIG. 13 is an exploded perspective view of a microstrip patch antenna according to a seventh embodiment of the present invention. FIGS. 14A through 14D are graphs illustrating a smith chart, a reflection coefficient, a radiation pattern, and an antenna gain characteristic of a microstrip patch antenna, respectively, according to the seventh embodiment.

Referring to FIG. 13, the microstrip patch antenna 700 of the seventh embodiment may have a structure similar to that of the sixth embodiment. Unlike the microstrip patch antenna 600 of the sixth embodiment, the microstrip patch antenna 700 of the seventh embodiment may include the patch layer 35 including at least one, for example, two substrates 351. Furthermore, the fourth substrate 401 may comprise two substrates 401.

The characteristics of the microstrip patch antenna 700 of the seventh embodiment may be similar to those of the sixth embodiment. Other than the two substrates 351 and the two substrates 401, all other component descriptions of the sixth embodiment or the first embodiment can be applied to this embodiment.

### Eighth Embodiment

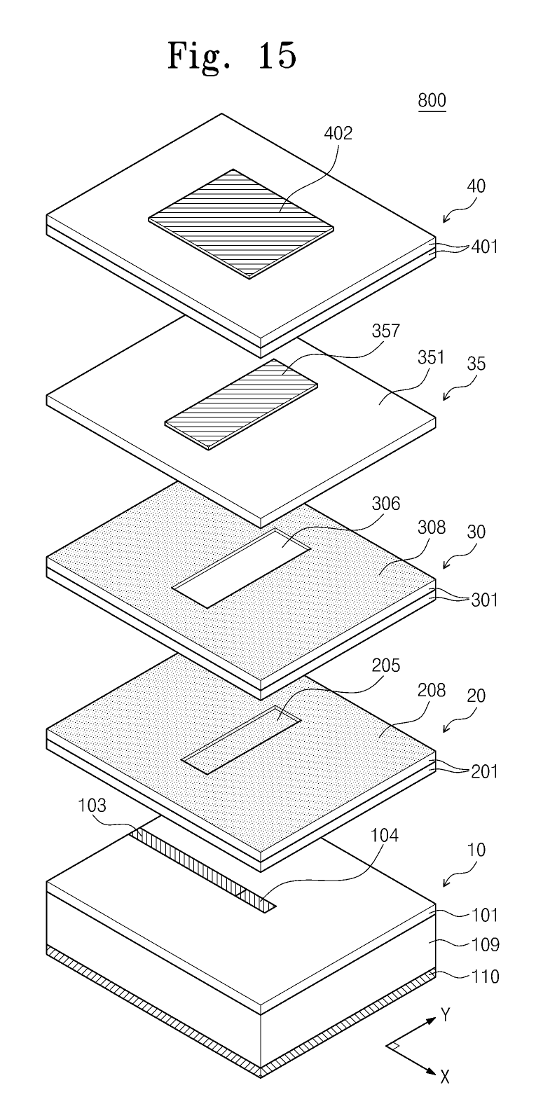

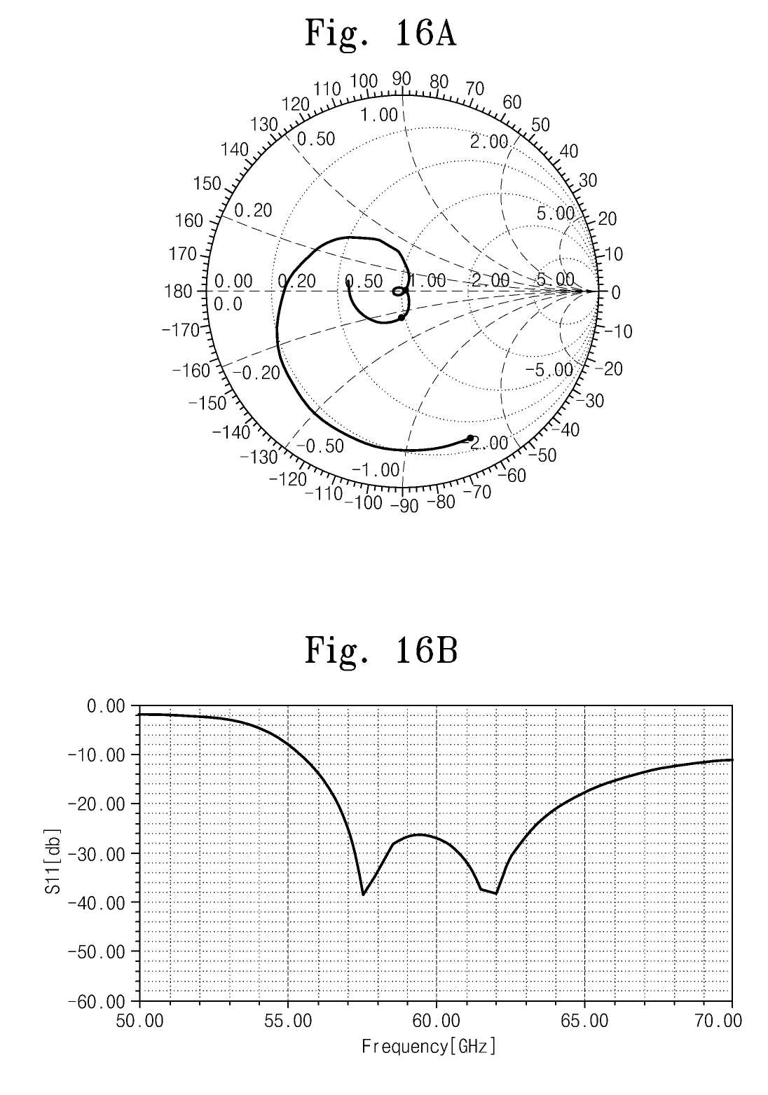

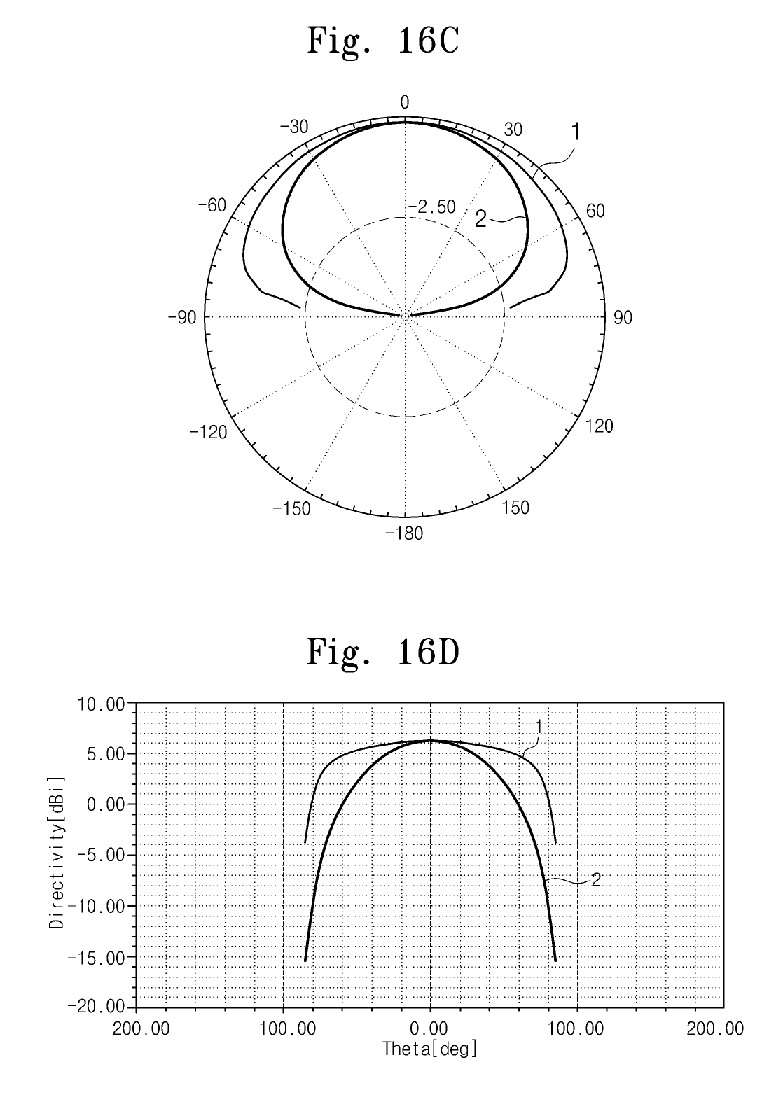

FIG. 15 is an exploded perspective view of a microstrip patch antenna according to an eighth embodiment. FIGS. 16A through 16D are graphs illustrating a smith chart, a reflection coefficient, a radiation pattern, and an antenna gain characteristic of a microstrip patch antenna, respectively, according to the eighth embodiment.

Referring to FIG. 15, the microstrip patch antenna 800 of the eighth embodiment has two third substrates 301 (its number is increased) and two fourth substrates 401 (its number is decreased) compared to the microstrip patch antenna 600 of the sixth embodiment. Except this, all other components are the same as the sixth embodiment. The micro patch antenna 800 may have a wideband characteristic (about 57 GHz to about 63 GHz) as shown in FIG. 16B and a high gain characteristic (about 6.3 dBi) as shown in FIG. 16D.

### Ninth Embodiment

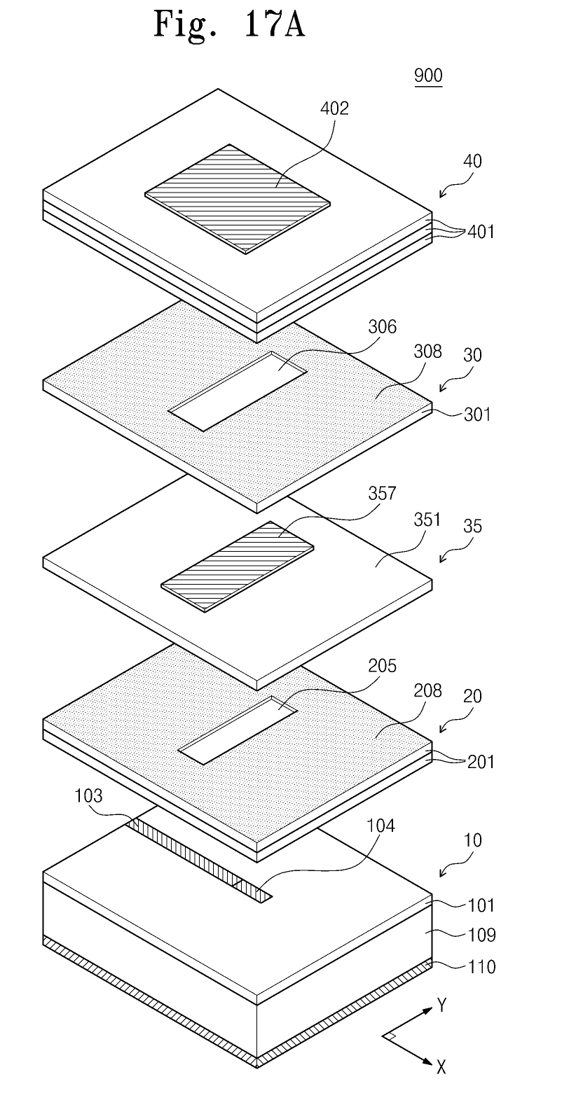

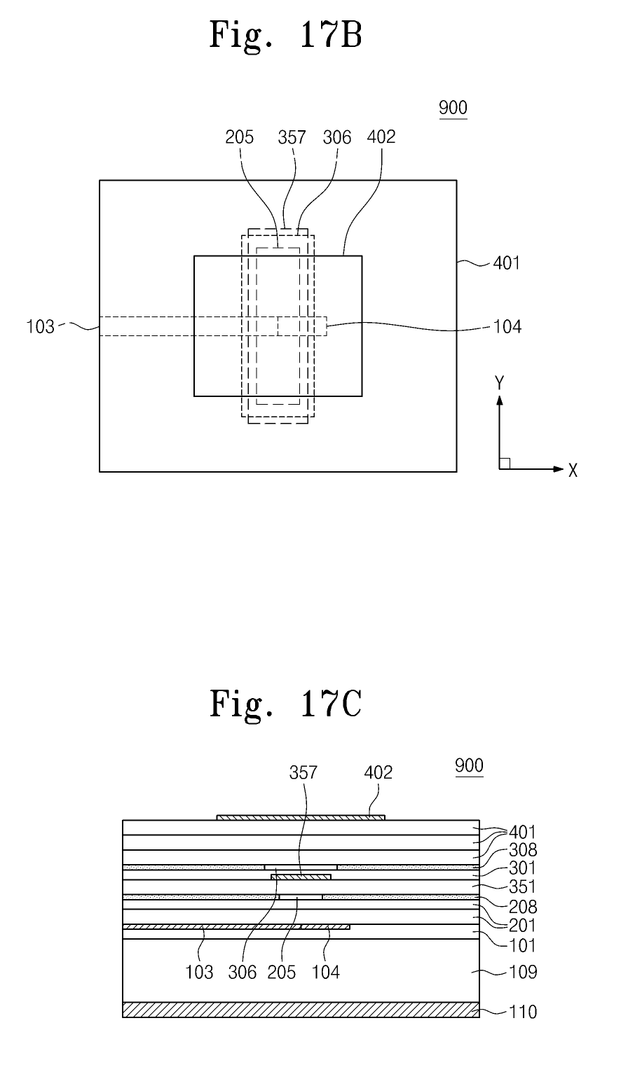

FIG. 17A is an exploded perspective view of a microstrip patch antenna according to a ninth embodiment of the present invention. FIG. 17B is a plan view of the microstrip patch antenna. FIG. 17C is a cross-sectional view of the microstrip patch antenna.

Referring to FIGS. 17A through 17C, the microstrip patch antenna 900 of the ninth embodiment may have a structure similar to that of the six embodiment. Unlike the microstrip patch antenna 600 of the sixth embodiment, the patch layer 35 including the substrate 351 and the patch 357 is further disposed between the second layer 20 and the third layer 30. Other than that, all the components are the same as the sixth embodiment.

A power is fed into the slot 205 through the microstrip feed line 103. The fed power is parasitically connected to the patch 357 between the slot 205 and the stack slot 306, and then, is fed into the stack slot 306 through the parasitically connected patch 357. The fed power is transmitted into the patch antenna 402 through the fourth substrate 401 on the stack slot 306. An input impedance from the feed line toward the patch antenna 402 may be an impedance sum of the slot 205, the stack slot 306, the patch 357, and the patch antenna 402. The size of the patch 357 may serve as a very informant important factor that determines a characteristic of the microstrip patch antenna 900.

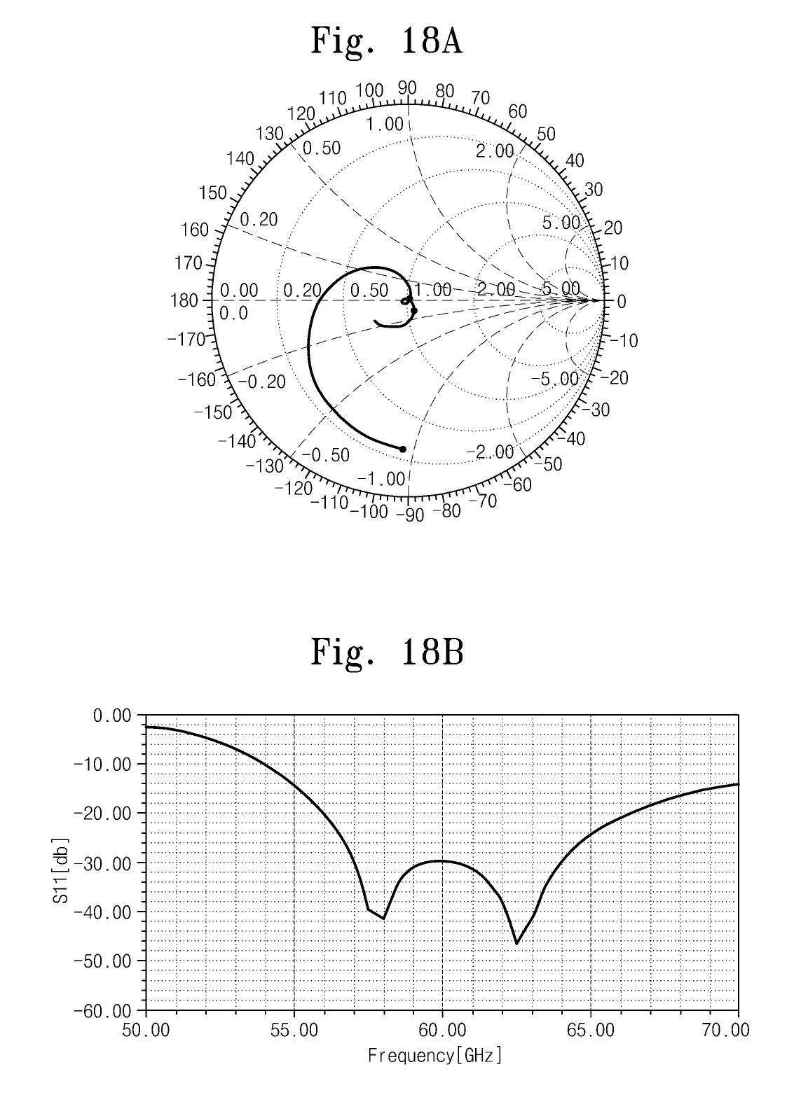

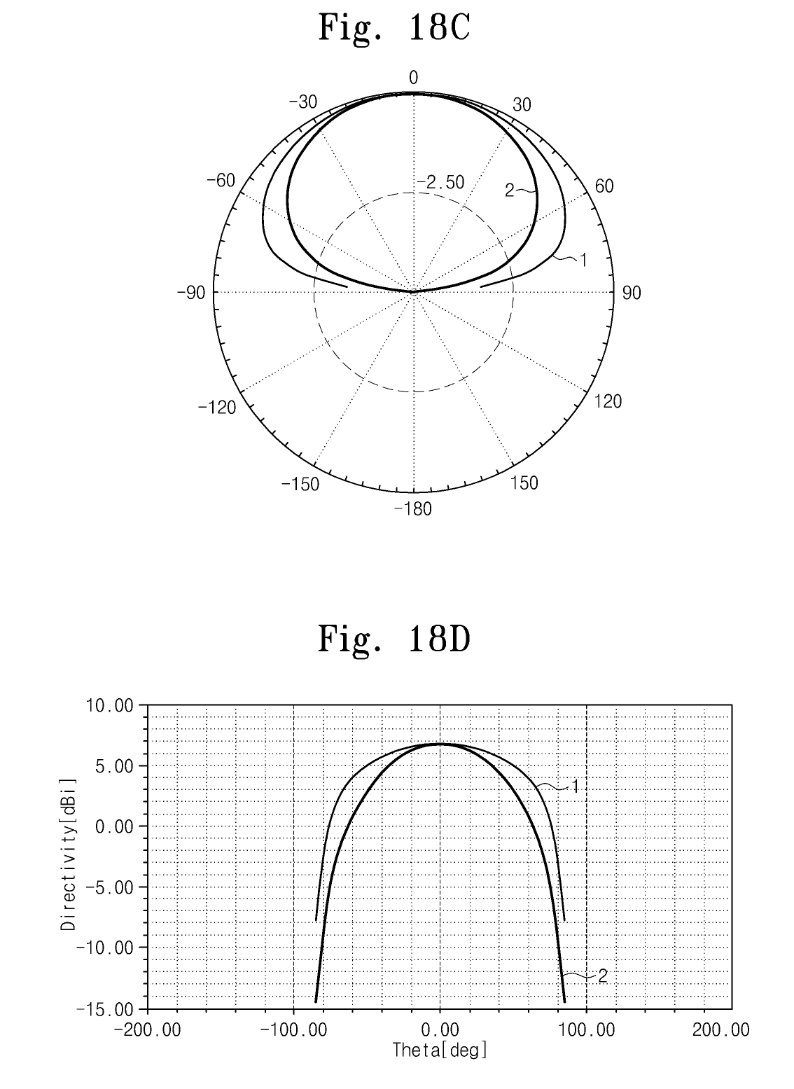

FIGS. 18A through 18D are graphs illustrating a smith chart, a reflection coefficient, a radiation pattern, and an antenna gain characteristic of the microstrip patch antenna 900, respectively, according to the ninth embodiment. As shown in FIG. 18B, with respect to a reflection coefficient of −30 dB, the microstrip patch antenna 900 may have a wideband characteristic having a frequency band of about 57 GHz to about 64 GHz. Furthermore, as illustrated in FIG. 18D, a high antenna gain characteristic of about 6.3 dBi can be obtained.

According to the present invention, a microstrip patch antenna of a stack slot structure with high gain and wide band characteristics can be realized.

Therefore, miniaturization and price lowering of System In Package (SIP) or System On Package (SOP) systems and modules become possible. Furthermore, since their structures are not relatively complex, manufacturing processes can be simplified.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A microstrip patch antenna comprising:
a dielectric layer;
a feed circuit disposed in the dielectric layer;
at least one slot disposed in the dielectric layer and vertically spaced apart from the feed circuit; and
a patch antenna disposed outside the dielectric layer and vertically spaced apart from the at least one slot.

2. The microstrip patch antenna of claim 1, wherein the dielectric layer comprises a stacked layer of a plurality of Low Temperature Co-fired Ceramic (LTCC) substrates, a plurality of silicon substrates, a plurality of printed circuit boards (PCBs), or a plurality of liquid crystal polymer (LCP) substrates.

3. The microstrip patch antenna of claim 1, wherein the feed circuit comprises an open line and a feed line of a microstrip line, a strip line, or an embedded line.

4. The microstrip patch antenna of claim 1, wherein the slot comprises a first slot and a second slot, the second slot being vertically spaced apart from the first slot and having a different size than the first slot.

5. The microstrip patch antenna of claim 1, further comprising an air cavity disposed below the feed circuit outside the dielectric layer.

6. The microstrip patch antenna of claim 1, further comprising a patch disposed in the dielectric layer and vertically spaced apart from the patch antenna.

7. The microstrip patch antenna of claim 6, wherein the patch is disposed between the patch antenna and the at least one slot or between the slots.

8. A microstrip patch antenna comprising:
a feed circuit layer including a feed line and an open line;
a slot layer stacked on the feed circuit layer, the slot layer including at least one slot; and
an antenna layer stacked on the slot layer, the antenna layer including a patch antenna.

9. The microstrip patch antenna of claim 8, wherein the feed circuit layer comprises:
a first dielectric substrate where the feed line and the open line are disposed; and
an air cavity disposed below the first dielectric substrate.

10. The microstrip patch antenna of claim 9, wherein the slot layer comprises:
a second dielectric substrate stacked on the first dielectric substrate, the second dielectric substrate including a first slot of a first size; and
a third dielectric substrate stacked on the second dielectric substrate, the third dielectric substrate including a second slot of a second size different from the first size.

11. The microstrip patch antenna of claim 10, wherein each of the second and third dielectric substrates further comprises a ground layer thereon.

12. The microstrip patch antenna of claim 10, wherein the antenna layer comprises a fourth dielectric substrate, the fourth dielectric substrate being stacked on the third dielectric substrate and having an open top surface on which the patch antenna is disposed.

13. The microstrip patch antenna of claim 12, wherein each of the first to fourth substrates comprises at least one LTCC (Low Temperature Co-fired Ceramic) substrate, at least one silicon substrate, at least one PCB (Printed Circuit Board), or at least one LCP (Liquid Crystal Polymer) substrate.

14. The microstrip patch antenna of claim 8, further comprising a patch layer disposed below the antenna layer, the patch layer including a dielectric substrate where a patch is disposed.

15. The microstrip patch antenna of claim 14, wherein the patch layer is disposed in the slot layer, and the patch is disposed between the slots.

16. The microstrip patch antenna of claim 14, wherein the patch layer is disposed above the slot layer, and the patch is disposed between the at least one slot and the patch antenna.

17. A microstrip patch antenna comprising:
a first dielectric substrate including a feed line and an open line;
a second dielectric substrate stacked on the first dielectric substrate and including a first slot;
a third dielectric substrate stacked on the second dielectric substrate and including a second slot, the second slot having a different size than the first slot;
a fourth dielectric substrate staked on the third dielectric substrate and having an open top surface on which a patch antenna is disposed; and
a fifth dielectric substrate disposed below the fourth dielectric substrate and having a top surface where a patch is disposed.

18. The microstrip patch antenna of claim 17, wherein the fifth dielectric substrate is disposed between the third and fourth dielectric substrates or between the second and third dielectric substrates.

19. The microstrip patch antenna of claim 17, wherein each of the first to fifth dielectric substrates comprises at least one LTCC (Low Temperature Co-fired Ceramic) substrate, at least one silicon substrate, at least one PCB (Printed Circuit Board), or at least one LCP (Liquid Crystal Polymer) substrate.

20. The microstrip patch antenna of claim 17, wherein each of the second and third dielectric substrates further comprises a ground layer thereon.
